(19) United States
(12) Patent Application Publication
(10) Pub. No.: US 2006/0222131 A1
(43) Pub. Date: Oct. 5, 2006

(54) Method for sampling reverse data and a reverse data sampling circuit for performing the same

(75) Inventor: Dong-Uk Park, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/369,033

(22) Filed: Mar. 6, 2006

(30) Foreign Application Priority Data
Mar. 29, 2005 (KR) 2005-25747

(51) Int. Cl. H04L 7/00

(52) U.S. Cl. 375/355; 375/371

(57) ABSTRACT

A method for sampling reverse data and a reverse data sampling circuit for performing the same are provided. The reverse data sampling method of a host interface device includes generating a multi-phase clock; sampling clocks corresponding to respective phases of the multi-phase clock at a transition of a reverse data signal to generate clock sampling signals; sampling the reverse data signal at a transition of the clocks corresponding to the respective phases of the multi-phase clock to generate data sampling signals; selecting a sampling clock from the clocks corresponding to the respective phases of the multi-phase clock by using the clock sampling signals and the data sampling signals; and sampling reverse data at a transition of the sampling clock.

### CROSS-REFERENCE TO RELATED APPLICATION

This application claims priority to Korean Patent Application No. 2005-25747, filed on Mar. 29, 2005 in the Korean Intellectual Property Office (KIPO), the disclosure of which is incorporated by reference herein in its entirety.

### BACKGROUND OF THE INVENTION

1. Technical Field

The present invention relates to bus interface systems, and more specifically, to a method and apparatus for sampling reverse data in a host of a bus interface system.

2. Discussion of the Related Art

Generally, to transmit/receive signals between integrated circuits (ICs), either a voltage mode transmission/reception operation or current mode transmission/reception operation is performed. Since the voltage mode transmission/reception operation introduces a resistive-capacitive delay when transmitting/receiving signals, the current mode transmission/reception operation is being researched to reduce the resistive/capacitive delay.

In the current mode transmission/reception operation, a current of a transmitted/received signal is observed. In particular, the current mode transmission/reception operation maintains a voltage level of a transmission line and transmits data by changing a current level flowing through the transmission line.

For example, a transmitter may sequentially transfer digital data by using logic values of ‘1’ and ‘0’. Thus, a current level of about 17 mA through 23 mA may be set to logic ‘1’ and a current level of about 0 mA through 6 mA may be set to logic ‘0’. A receiver may recover the received digital data by determining the current level of the transmitted signals. Because the voltage level is maintained in the current mode transmission/reception operation, the resistive-capacitive delay may be reduced.

In a ‘pseudo-differential’ current mode transmission/reception operation, the transmitter may transmit a reference current with a data current. For example, the transmitter may set the current level of about 17 mA through 23 mA to logic ‘1’ and the current level of about 0 mA through 6 mA to logic ‘0’ to transmit a data current based on the set levels. In addition, the transmitter may transmit the reference current of about 10 mA with the data current.

The receiver may receive the data current and the reference current and compare an amount of the data current with that of the reference current to determine the logic value of the received data. Thus, for example, when the amount of the data current is more than that of the reference current, the received data is logic ‘1’, and when the amount of the data current is less than that of the reference current, the received data is logic ‘0’.

As various applications and devices such as a cellular phone and a digital camera continue to become integrated, the need to support bi-directional data transfer between a cellular phone module and a digital camera module is increasing. In other words, the ability to sample forward data provided from a host to a client during a forward transmission mode and reverse data provided from the client to the host during a reverse transmission mode is needed in such devices.

However, when the client does not provide a clock for sampling the reverse data in the reverse transmission mode, it is difficult for the host to efficiently sample the reverse data at an appropriate time. Therefore, a need exists for an apparatus and method that is capable of sampling the reverse data in an efficient manner at an appropriate time.

### SUMMARY OF THE INVENTION

In an embodiment of the present invention, a method of sampling reverse data in a host interface device includes generating a multi-phase clock, sampling clocks corresponding to respective phases of the multi-phase clock at a transition of a reverse data signal to generate clock sampling signals, sampling the reverse data signal at a transition of the clocks corresponding to the respective phases of the multi-phase clock to generate data sampling signals, selecting a sampling clock from the clocks corresponding to the respective phases of the multi-phase clock by using the clock sampling signals and the data sampling signals, and sampling reverse data at a transition of the sampling clock.

Selecting the sampling clock may include selecting a clock that transitions in the same direction as the transition of the reverse data signal after the transition of the reverse data signal, from the clocks corresponding to the respective phases of the multi-phase clock. The transition of the reverse data signal may correspond to a rising edge of the reverse data signal and the transition of the clocks may correspond to a rising edge of the clocks corresponding to the respective phases of the multi-phase clock. In addition, the host interface device may be included in a current mode bus interface system. Further, the transition of the sampling clock corresponds to a falling edge of the sampling clock.

Selecting the sampling clock may include selecting a clock corresponding to the data sampling signal sampled with a first logic level, when a phase of the multi-phase clock corresponding to the clock sampling signal with the first logic level and a phase of the multi-phase clock corresponding to the data sampling signal with the first logic level, correspond to a time delay of the multi-phase clock. In addition, selecting the sampling clock may include selecting a clock C_{N+1}, when a clock sampling signal P_{N} and a data sampling signal Q_{N+1} have the first logic level, where the clock C_{N} is a clock corresponding to an N-th phase of the multi-phase clock, the clock sampling signal P_{N} indicates that the clock C_{N} is sampled at a rising edge of the reverse data signal, and the data sampling signal Q_{N+1} indicates that the reverse data signal is sampled at a rising edge of the clock C_{N+1}.

Selecting the sampling clock may also include selecting a clock C_{N+1}, when clock sampling signals P_{N} through P_{N+1} and data sampling signals Q_{N+1} through Q_{N+2} have the first logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the clocks C_{N+1} and C_{N+2}.

In addition, selecting the sampling clock may include selecting a clock C_{N+1}, when a clock sampling signal P_{N} and a data sampling signal Q_{N+2} have the first logic level, and a clock sampling signal P_{N+1} and a data sampling signal Q_{N+1} have a second logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the clocks C_{N+1} and C_{N+2}. The first logic level may correspond to a logic ‘high’ and the second logic level may correspond to a logic ‘low’.

In another embodiment of the present invention, a reverse data sampling circuit of a host interface device may include a multi-phase clock generation unit configured to generate a multi-phase clock, a selection signal generation unit, a selection unit and a sampling unit.

The selection signal generation unit samples clocks corresponding to respective phases of the multi-phase clock to generate clock sampling signals at a transition of a reverse data signal, sample the reverse data signal at a transition of the clocks corresponding to the respective phases of the multi-phase clock to generate data sampling signals, and generate a selection signal by using the clock sampling signals and the data sampling signals. The selection unit selects a sampling clock from the clocks corresponding to the respective phases of the multi-phase clock by using the selection signal. The sampling unit samples reverse data at a transition of the sampling clock.

The selection signal generation unit may select, as the sampling clock, a clock that transitions in the same direction as the transition of the reverse data signal after the transition of the reverse data signal, from the clocks corresponding to the phases of the multi-phase clock. The transition of the reverse data signal may correspond to a rising edge of the reverse data signal and the transition of the clocks may correspond to a rising edge of the clocks corresponding to the respective phases of the multi-phase clock. In addition, the host interface device may be included in a current mode bus interface system. Further, the sampling unit may sample the reverse data at a falling edge of the sampling clock.

The selection signal generation unit may select, as the sampling clock, a clock corresponding to the data sampling signal sampled with a first logic level, when the clock sampling signal with the first logic level corresponding to the multi-phase clock, and the data sampling signal with the first logic level corresponding to the multi-phase clock, correspond to a time delay of the multi-phase clock.

The selection signal generation unit may select the sampling clock by selecting a clock C_{N+1}, when a clock sampling signal P_{N} and a data sampling signal Q_{N+1} have the first logic level, where the clock C_{N} is a clock corresponding to an N-th phase of the multi-phase clock, the clock sampling signal P_{N} indicates that the clock C_{N} is sampled at a rising edge of the reverse data signal, and the data sampling signal Q_{N+1} indicates that the reverse data signal is sampled at a rising edge of the clock C_{N+1}.

The selection signal generation unit may select the sampling clock by selecting a clock C_{N+1}, when clock sampling signals P_{N} through P_{N+1} and data sampling signals Q_{N+1} through Q_{N+2} have the first logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the clocks C_{N+1} and C_{N+2}.

The selection signal generation unit may select the sampling clock by selecting a clock C_{N+1}, when a clock sampling signal P_{N} and a data sampling signal Q_{N+2} have the first logic level, and a clock sampling signal P_{N+1} and a data sampling signal Q_{N+1} have a second logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the respective clocks C_{N+1} and C_{N+2}. The first logic level may be a logic ‘high’ and the second logic level may be a logic ‘low’.

The selection signal generation unit comprises: a flip-flop unit including a plurality of flip-flops, the flip-flop unit samples the clocks corresponding to the respective phases of the multi-phase clock at the transition of the reverse data signal to generate the clock sampling signals, and samples the reverse data signal at the transition of the clocks corresponding to the phases of the multi-phase clock to generate the data sampling signals; and a signal generation unit generates the selection signal by using the clock sampling signals and the data sampling signals.

### BRIEF DESCRIPTION OF THE DRAWINGS

The above and other features of the present invention will become more apparent by describing in detail exemplary embodiments thereof with reference to the accompanying drawings, where:

FIG. 1 is a block diagram illustrating a current mode bus interface system according to an exemplary embodiment of the present invention;

FIG. 2 is a timing diagram illustrating a reverse data transmission of the current mode bus interface system in FIG. 1;

FIG. 3 is a timing diagram illustrating a clock current and a data current in a forward transmission mode of the current mode bus interface system in FIG. 1;

FIG. 4 is a timing diagram illustrating a clock current and a reverse data current in a reverse transmission mode of the current mode bus interface system in FIG. 1;

FIG. 5 is a timing diagram illustrating a reverse data reception in the current mode bus interface system of FIG. 1;

FIG. 6 is a timing diagram illustrating sampling of reverse data by using four multi-phase clocks;

FIG. 7 is a circuit diagram illustrating a method for sampling reverse data according to an exemplary embodiment of the present invention;

FIG. 8 is a timing diagram illustrating a general reverse data sampling method in a host interface device according to an exemplary embodiment of the present invention;

FIG. 9 is a timing diagram illustrating a reverse data sampling method in a host interface device for a robust design according to an exemplary embodiment of the present invention;

FIG. 10 is a block diagram illustrating a reverse data sampling circuit of the host interface device according to an exemplary embodiment of the present invention; and

FIG. 11 is a block diagram illustrating an exemplary embodiment of a selection signal generation unit in FIG. 10.

### DESCRIPTION OF EXEMPLARY EMBODIMENTS

Hereinafter, exemplary embodiments of the present invention will be explained with reference to the accompanying drawings. However, specific structural and functional details disclosed herein are merely presented for purposes of describing the exemplary embodiments of the present invention.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

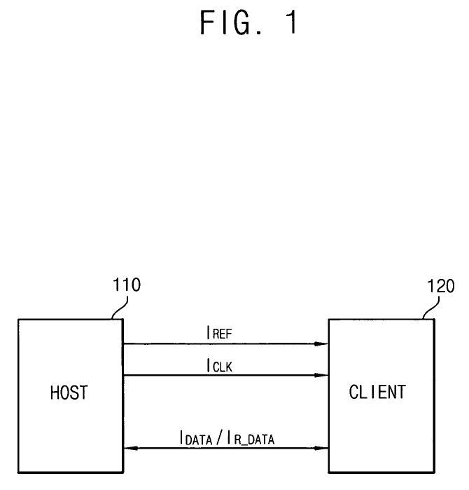

FIG. 1 is a block diagram illustrating a current mode bus interface system according to an exemplary embodiment of the present invention.

Referring to FIG. 1, the current mode bus interface system may include a current mode host interface device 110 and a current mode client interface device 120. Hereinafter, the current mode host interface device 110 and the current mode client interface device 120 may be referred to as a host 110 and a client 120, respectively.

The current mode host interface device 110 may transmit a reference current I_{REF} and a clock current I_{CLK} to the current mode client interface device 120. The current mode host interface device 110 may also transmit a data current I_{DATA} to the current mode client interface device 120 in a forward transmission mode. The current mode host interface device 110 may receive a reverse data current I_{R}_{_{—}}_{DATA} from the client mode interface device 120 in a reverse transmission mode, and compare the reverse data current I_{R}_{_{—}}_{DATA} with the reference current I_{REF} to generate a reverse data voltage.

The current mode client interface device 120 may receive the reference current I_{REF} and the clock current I_{CLK} from the current mode host interface device 110 and compare the reference current I_{REF} with the clock current I_{CLK} to generate a clock voltage. The current mode client interface device 120 may also receive the data current I_{DATA} from the current mode host interface device 110 in a forward transmission mode and compare the data current I_{DATA} with the received reference current I_{REF} to generate the data voltage. In addition, the current mode client interface device 120 may transmit the reverse data current I_{R}_{_{—}}_{DATA} in a reverse transmission mode through a conducting wire over which the data current I_{DATA} is received.

As shown, for example, in FIG. 1, when the clock current I_{CLK}, the data current I_{DATA} and the reverse data current I_{R}_{_{—}}_{DATA} have a current level of about 300 μA, they may be set to a logic ‘low’ and when they have a current level of about 100 μA, they may be set to a logic ‘high’.

The reference current I_{REF} may have a current level of about 200 μA and since an amount of data that is transmitted from the host 110 to the client 120 is smaller than that transmitted from the client 120 to the host 110, the reverse data current I_{R}_{_{—}}_{DATA} may have a frequency lower than that of the data current I_{DATA}.

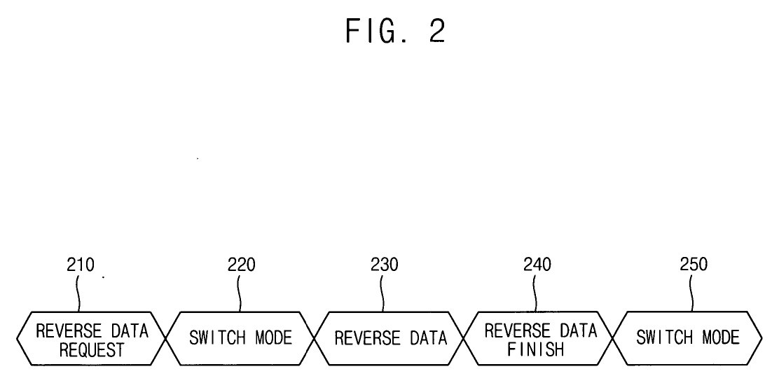

FIG. 2 is a timing diagram illustrating a reverse data transmission of the current mode bus interface system in FIG. 1.

Referring to FIG. 2, data transmission of the current mode bus interface system may be initiated by a reverse data transmission request from the host 110.

As shown in FIG. 2, the host 110 sends a reverse data request packet to the client 120 for initiating the transmission of the reverse data (step 210).

The host 110, which transmits the reference current I_{REF} and the clock current I_{CLK} continuously, switches from a forward transmission mode to a reverse transmission mode. The client 120 acknowledges the reverse data request packet and switches from a forward transmission mode to a reverse transmission mode (step 220).

After both the host 110 and the client 120 switch to the reverse transmission mode, the client 120 begins to transmit the reverse data (step 230).

After the client 120 transmits all of the reverse data, the client 120 sends a reverse data completion packet to the host 110 (step 240).

After the client 120 sends the reverse data completion packet to the host 110, the client 120 switches back to the forward transmission mode. Upon receipt, of the reverse data completion packet, the host 110 acknowledges receipt thereof and switches back to the forward transmission mode (step 250).

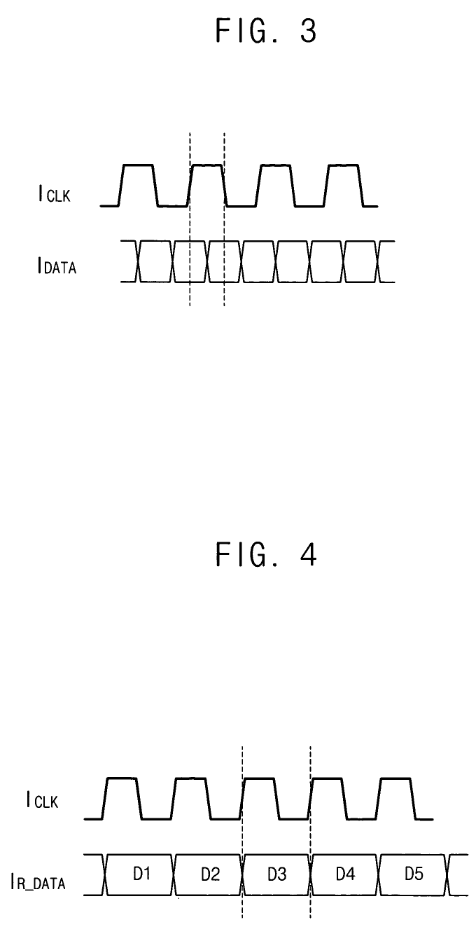

FIG. 3 is a timing diagram illustrating a clock current I_{CLK} and a data current I_{DATA} in a forward transmission mode of the current mode bus interface system in FIG. 1.

Referring to FIG. 3, in the forward transmission mode, two data currents I_{DATA} are transmitted during one period of the clock current I_{CLK}. Additionally, in the forward transmission mode, there is a 90-degree phase difference between a transition of the clock current I_{CLK} and a transition of the data current I_{DATA}.

Therefore, if the client 120 samples data at a rising edge or a falling edge of the clock current I_{CLK}, the client 120 may effectively receive the data. It is to be understood by one of ordinary skill in the art that the operation illustrated in FIG. 3 may be applied to a voltage mode bus interface system.

FIG. 4 is a timing diagram illustrating a clock current I_{CLK} and a reverse data current I_{R}_{_{—}}_{DATA} in a reverse transmission mode of the current mode bus interface system in FIG. 1.

Referring to FIG. 4, in the reverse transmission mode, one data current I_{R}_{_{—}}_{DATA} is transmitted during one period of the clock current I_{CLK}. Additionally, in the reverse transmission mode, the transition of the clock current I_{CLK} and the transition of the reverse data current I_{R}_{_{—}}_{DATA} occur concurrently.

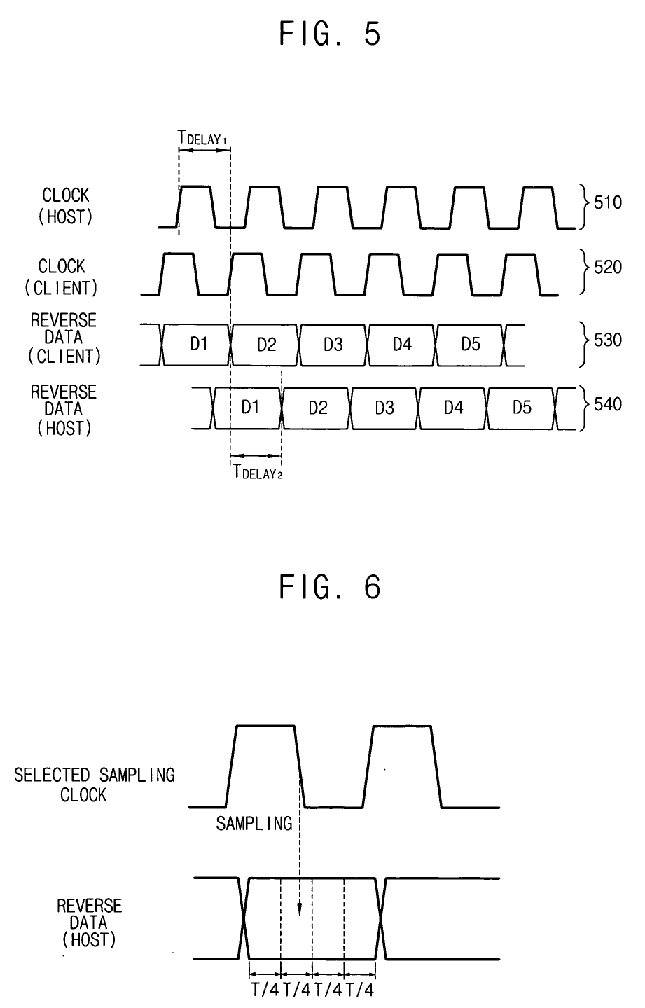

Thus, a frequency of the reverse data current I_{R}_{_{—}}_{DATA} in FIG. 4 is lower than that of the data current I_{DATA} in FIG. 5 because an amount of data transmitted from the client 120 to the host 110 is often smaller than that transmitted from the host 110 to the client 120.

It is to be understood by one of ordinary skill in the art that the operation of FIG. 4 may be applied to a voltage mode bus interface system.

FIG. 5 is a timing diagram illustrating a reverse data reception according to an exemplary embodiment of the current mode bus interface system of FIG. 1.

Referring to FIG. 5, a clock 510 delayed by a predetermined time T_{DELAY1} is transmitted from the host 110 to the client 120. The predetermined time T_{DELAY1} may be determined according to an operating environment such as a printed circuit board (PCB) on which the current mode bus interface system is located.

The client 120 synchronizes a clock 520 to be transmitted from the client 120 with the clock 510 and generates reverse data 530 to be transmitted to the host 110.

The reverse data 530 sent by the client 120 is delayed by a predetermined time T_{DELAY2}. When a transmission environment and a reception environment are equivalent, the predetermined time T_{DELAY2} may be equivalent to the predetermined time T_{DELAY1}. In other words, a delay time between the clock 510 received from the host 110 and the clock 520 transmitted from the client 120 may be the same.

FIG. 6 is a timing diagram illustrating sampling of reverse data by using four multi-phase clocks.

Referring to FIG. 6, the host 110 samples the reverse data received from the client 110 by using the four multi-phase clocks. The multi-phase clocks may be generated by using a phase-locked loop (PLL) or a delay-locked loop (DLL).

When the host 110 samples the reverse data by using the four multi-phase clocks, an appropriate sampling clock may be selected from clocks corresponding to the respective multi-phase clocks.

The sampling clock should be selected such that it has a maximum time error of about one-fourth a period T of the sampling clock. In addition, the sampling clock should be selected from a clock located near a central point of the period T where the time error has a high chance of occurring. Thus, if an appropriate sampling clock is selected, the time error may decrease by about T/4.

When, for example, eight multi-phase clocks are used, if an appropriate sampling clock is selected, a time error may decrease by about a T/8.

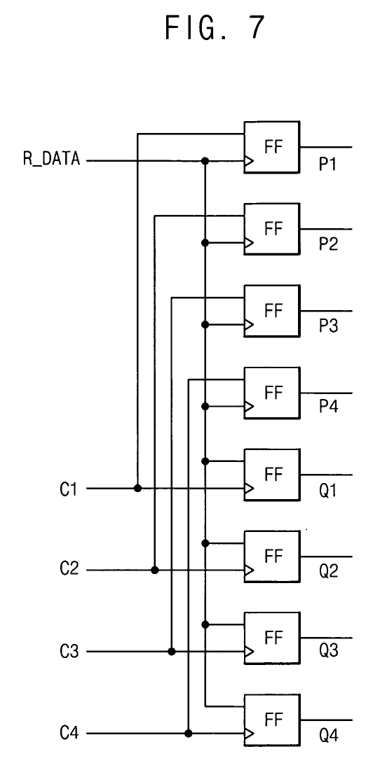

A method for selecting an appropriate sampling clock from the clocks corresponding to the respective multi-phase clocks will be described hereinafter with reference to FIGS. 7 through 9.

FIG. 7 is a circuit diagram illustrating a method for sampling reverse data according to an exemplary embodiment of the present invention.

The method for sampling the reverse data includes selecting a sampling clock by selecting a clock that transitions at a time similar to that of the reverse data signal, and then sampling the reverse data at a falling edge of the sampling clock.

Referring to FIG. 7, clocks C1 through C4 corresponding to respective multi-phase clocks at a rising edge of a received reverse data signal R_DATA are sampled by a first set of flip-flops to generate clock-sampling signals P1 through P4.

Additionally, the reverse data signal R_DATA is sampled at a rising edge of the clocks C1 through C4 by a second set of flip-flops to generate data sampling signals Q1 through Q4.

In the reverse data sampling method, an appropriate sampling clock for sampling the reverse data is selected from the clocks C1 through C4 by selecting a clock C_{N+1} corresponding to an (N+1)-th phase of the multi-phase clocks when an N-th clock sampling signal P_{N} and an (N+1)-th data sampling signal Q_{N+1} are at logic ‘high’.

In other words, a sampling clock is selected by selecting a clock corresponding to the data sampling signal sampled with a logic ‘high’, when a phase of the multi-phase clock corresponding to the clock sampling signal with a logic ‘high’ and a phase of the multi-phase clock corresponding to the data sampling signal with a logic ‘high’, correspond to a time delay of the multi-phase clock. Thus, a clock that has a rising edge immediately after a rising edge of the reverse data signal R_DATA is selected as the sampling clock.

In addition, a clock, which transitions at a time similar to that of the reverse data signal R_DATA, may also be selected as the sampling clock. Consequently, a circuit for the bus interface system may be easily configured to quickly select the sampling clock by using a flip-flop for generating the data sampling signals and the clock sampling signals, and a multiplexer for selecting the sampling clocks.

As further shown in FIG. 7, the reverse data signal R_DATA may correspond to the current mode signal or a voltage mode signal of a voltage mode bus interface system. In addition, when selecting the sampling clock, a frequency of the reverse data signal R_DATA may be equivalent to that of a clock received from the host 110 when the host 110 is initially turned on.

In other words, the reverse data may be transmitted with a frequency, which is lower than a frequency of a received clock. However, when selecting the sampling clock at system power-on, the client 120 may transmit a clock that is received from the host 110. In this case, the sampling clock is selected only once at system power-on and then the selected sampling clock may be used in every reverse data transmission.

For a robust design, when the N-th clock sampling signal P_{N}, the (N+1)-th data sampling signal Q_{N+1}, the (N+1)-th clock sampling signal P_{N+1} and the (N+2)-th data sampling signal Q_{N+2} are logic ‘high’, a clock C_{N+1} corresponding to an (N+1)-th phase of the multi-phase clocks may be selected as the sampling clock.

Additionally, for a robust design, when both the N-th clock sampling signal P_{N} and the (N+2)-th data sampling signal Q_{N+2} are logic ‘high’ and both the (N+1)-th clock sampling signal P_{N+1} and the (N+1)-th data sampling signal Q_{N+1} are logic ‘low’, a clock C_{N+1} corresponding to the (N+1)-th phase of the multi-phase clock may be selected as the sampling clock.

Although these conditions do not typically occur, they may take place when the transition of a clock corresponding to the phase of one of the multi-phase clocks and the transition of the reverse data signal occur concurrently or when a jitter of the clock is very high.

In FIG. 7, when the clock sampling signals P1 through P4 and the data sampling signals Q1 through Q4 are logic ‘low’, the sampling clock may not be selected.

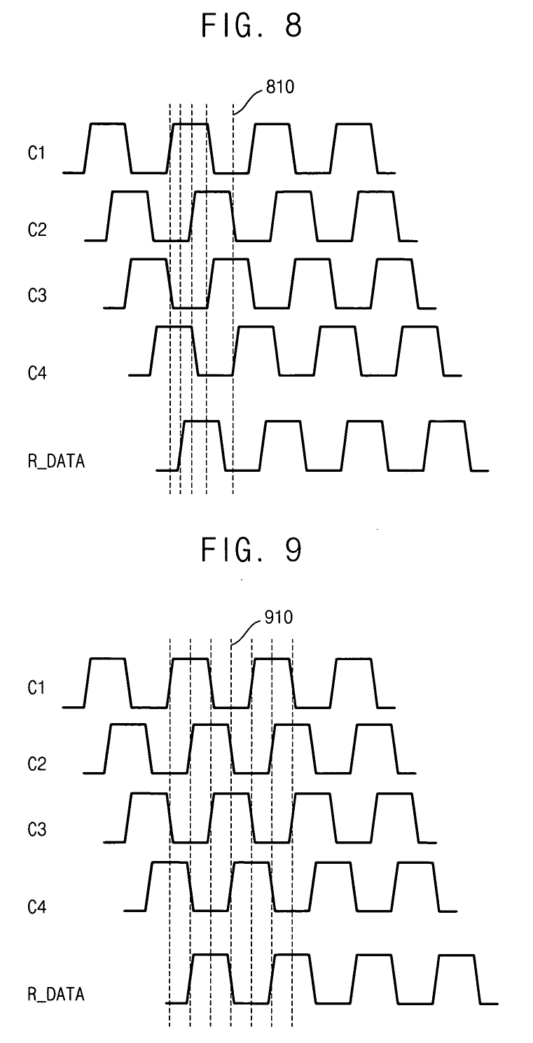

FIGS. 8 and 9 are timing diagrams illustrating a reverse data sampling method of a host interface device according to an exemplary embodiment of the present invention.

FIG. 8 is a timing diagram illustrating a general reverse data sampling method in the host interface according to an exemplary embodiment of the present invention.

Referring to FIG. 8, there is a 90-degree phase difference between the clocks C1 through C4 corresponding to the respective phases of the four multi-phase clocks. Here, the host 110 generates the clock sampling signals and the data sampling signals by using the clocks C1 through C4 and the reverse data signal R_DATA.

The following Table 1 summarizes the above description.

TABLE 1

| | | | |
|---|---|---|---|
| P1 | Q2 | 1 | 1 |
| P2 | Q3 | 0 | 1 |
| P3 | Q4 | 0 | 0 |
| P4 | Q1 | 1 | 0 |

In Table 1, P1 through P4 represent the clock sampling signals by which the clocks C1 through C4 corresponding to the phases 0 degrees, 90 degrees, 180 degrees and 270 degrees of the respective multi-phase clocks are sampled by the reverse data signal R_DATA.

Additionally, symbols Q1 through Q4 represent the data sampling signals by which the clocks C1 through C4 corresponding to the phases 0 degrees, 90 degrees, 180 degrees and 270 degrees of the respective multi-phase clocks are sampled by the reverse data signal R_DATA.

As illustrated in Table 1, because P1 and Q2 are logic ‘high’, the clock C2 corresponding to the 90 degree phase of the multi-phase clocks is selected as the sampling clock. As illustrated in the FIG. 8, a rising edge of the clock C2 occurs immediately after a rising edge of the reverse data signal R_DATA. Therefore, if the reverse data is sampled at a falling edge 810 of the clock C2, the reverse data may be effectively sampled.

FIG. 9 is a timing diagram illustrating the reverse data sampling method of a host interface device for a robust design according to an exemplary embodiment of the present invention.

Referring to FIG. 9, the clocks C1 through C4 corresponding to respective phases of the four multi-phase clocks have a 90-degree phase difference. The host 110 generates the clock sampling signals and the data sampling signals by using the clocks C1 through C4 and the reverse data signal R_DATA.

In FIG. 9, because the clock C2 and the reverse data signal R_DATA have a rising edge at similar times, the scenarios illustrated by the following Tables 2 and 3 may occur.

TABLE 2

| | | | |
|---|---|---|---|
| P1 | Q2 | 1 | 1 |
| P2 | Q3 | 1 | 1 |
| P3 | Q4 | 0 | 0/1 |
| P4 | Q1 | 0/1 | 1 |

TABLE 3

| | | | |
|---|---|---|---|
| P1 | Q2 | 1 | 0 |
| P2 | Q3 | 0 | 1 |
| P3 | Q4 | 0 | 0/1 |
| P4 | Q1 | 0/1 | 0 |

In Tables 2 and 3, P1 through P4 represent the clock sampling signals by which the clocks C1 through C4 corresponding to the phases 0 degrees, 90 degrees, 180 degrees and 270 degrees of the respective multi-phase clocks are sampled by the reverse data signal R_DATA.

Additionally, Q1 through Q4 represent the data sampling signals by which the clocks C1 through C4 corresponding to the phases 0 degrees, 90 degrees, 180 degrees and 270 degrees of the respective multi-phase clocks are sampled by the reverse data signal R_DATA.

As shown in Table 2, a scenario where the N-th clock sampling signal P_{N} and the (N+1)-th data sampling signal Q_{N+1} have a logic ‘high’ may occur more than twice. Here, the clock C2 is selected as the sampling clock and the reverse data is sampled at a falling edge 910 of the clock C2.

In Table 3, a scenario where the N-th clock sampling signal P_{N} and the (N+1)-th data sampling signal Q_{N+1} have a logic ‘high’ may not occur. Here, the clock C2 is selected as the sampling clock and the reverse data is sampled at the falling edge 910 of the clock C2.

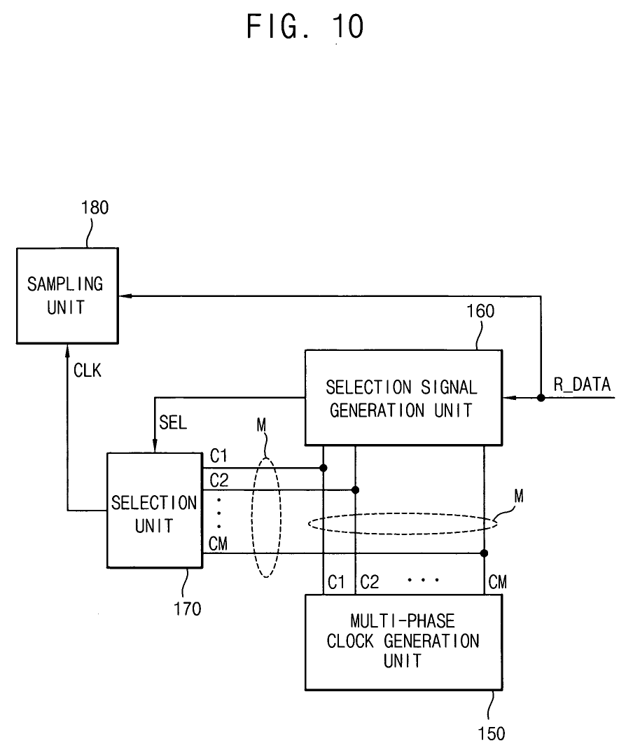

FIG. 10 is a block diagram illustrating a reverse data sampling circuit of the host interface device according to an exemplary embodiment of the present invention.

Referring to FIG. 10, the reverse data sampling circuit of the host interface device may include a multi-phase clock generation unit 150, a selection signal generation unit 160, a selection unit 170 and a sampling unit 180.

The multi-phase clock generation unit 150 generates a multi-phase clock, which may be implemented by the PLL and the DLL.

The selection signal generation unit 160 samples clocks C1 through CM corresponding to phases of the multi-phase clock by using a transition of the reverse data signal R_DATA to generate clock sampling signals. The selection signal generation unit 160 also samples the reverse data signal R_DATA by using transitions of the clocks C1 through CM, and generates a selection signal SEL by using the clock sampling signals and the data sampling signals.

The number of bits of the selection signal SEL may be equivalent to a number of bits used to select one of the clocks C1 through CM. For example, when M is 4, then the number of bits of the selection signal SEL may be 2.

The selection signal generation unit 160 may generate the selection signal SEL for selecting the sampling clock CLK by selecting a clock that transitions in the same direction as the transition of the reverse data signal R_DATA immediately after the transition of the reverse data signal R_DATA from the clocks C1 through CM.

For example, the selection signal generation unit 160 may generate the selection signal SEL for selecting a sampling clock CLK by selecting a clock that has a rising edge immediately after the rising edge of the reverse data signal R_DATA from the clocks C1 through CM.

The selection signal generation unit 160 may generate the selection signal SEL by using the reverse data sampling methods described with reference to FIGS. 7 through 9.

The selection unit 170 selects the sampling clock from the clocks C1 through CM. The selection unit 170 may be implemented with a multiplexer.

The sampling unit 180 samples the reverse data R_DATA by using the sampling clock CLK. For example, the sampling unit 180 may sample the reverse data R_DATA at a falling edge of the sampling clock CLK. The sampling unit 180 may be implemented with a flip-flop.

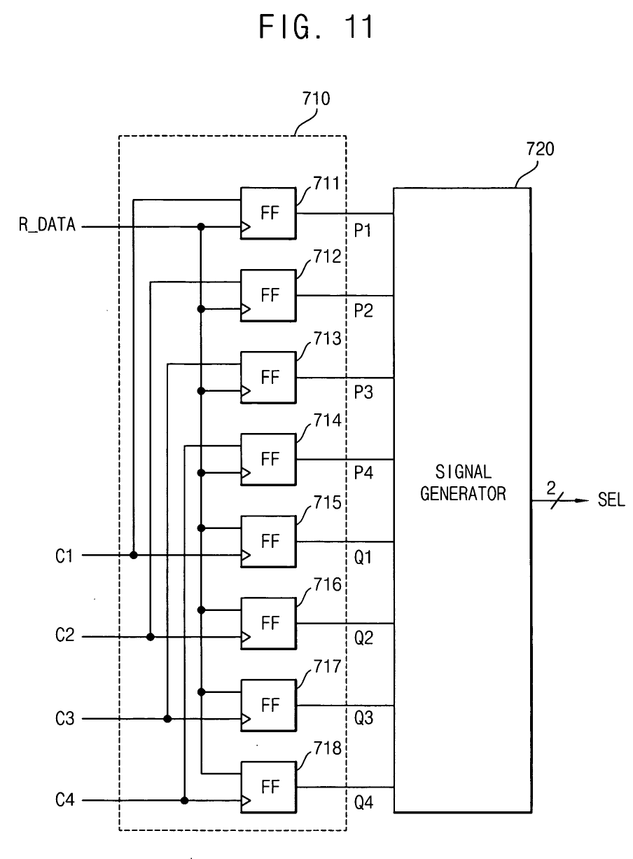

FIG. 11 is a block diagram illustrating an exemplary embodiment of the selection signal generation unit 160 in FIG. 10.

Referring to FIG. 11, the selection signal generation unit 160 may include a flip-flop unit 710 and a signal generation unit 720.

The flip-flop unit 710 may include flip-flops 711 through 718.

The flip-flop unit 710 samples the clocks C1 through C4 by using a transition of the reverse data signal R_DATA to generate the clock sampling signals P1 through P4, and samples the reverse data signal R_DATA by using a transition of the clocks C1 through C4 to generate the data sampling signals Q1 through Q4.

The signal generation unit 720 generates the selection signal SEL by using the clock sampling signals P1 through P4 and the data sampling signals Q1 through Q4.

The signal generation unit 720 may generate the selection signal SEL by the methods described with reference to FIGS. 7 through 9, and may be implemented with a basic logic circuit or a microcontroller.

For example, the signal generation unit 720 may generate a selection signal SEL with a value “01” to select a sampling clock by selecting the clock C2 corresponding to the 90 degree phase of the multi-phase clocks, when the first clock sampling signal P1 and the second data sampling signal Q2 are logic ‘high’.

As described above, although the reverse data sampling method and the reverse data sampling circuit of the host interface device according to an exemplary embodiment of the present invention have a propagation delay between the host 110 and the client 120, the method and the device may still efficiently sample the reverse data.

Additionally, since the reverse data sampling circuit of the host interface device may be easily configured by using a flip-flop and a multiplexer, the circuit may quickly sample the reverse data. Therefore, the circuit and method may be easily implemented in an application for transmitting reverse data.

While the present invention has been particularly shown and described with reference to exemplary embodiments thereof, it will be understood by those of ordinary skill in the art that various changes in form and details may be made therein without departing from the spirit and scope of the present invention as defined by the following claims.

For example, although the exemplary embodiments of the present invention have been described as being applied a current mode bus interface system, it is to be understood that the exemplary embodiments may be applied to a voltage mode bus interface system.

What is claimed is:

1. A method of sampling reverse data of a host interface device, the method comprising:
generating a multi-phase clock;
sampling clocks corresponding to respective phases of the multi-phase clock at a transition of a reverse data signal to generate clock sampling signals;
sampling the reverse data signal at a transition of the clocks corresponding to the respective phases of the multi-phase clock to generate data sampling signals;
selecting a sampling clock from the clocks corresponding to the respective phases of the multi-phase clock by using the clock sampling signals and the data sampling signals; and
sampling reverse data at a transition of the sampling clock.

2. The method of claim 1, wherein selecting the sampling clock comprises selecting a clock that transitions in the same direction as the transition of the reverse data signal after the transition of the reverse data signal, from the clocks corresponding to the respective phases of the multi-phase clock.

3. The method of claim 2, wherein the transition of the reverse data signal corresponds to a rising edge of the reverse data signal and the transition of the clocks corresponds to a rising edge of the clocks corresponding to the respective phases of the multi-phase clock.

4. The method of claim 3, wherein selecting the sampling clock comprises selecting a clock corresponding to the data sampling signal sampled with a first logic level, when a phase of the multi-phase clock corresponding to the clock sampling signal with the first logic level and a phase of the multi-phase clock corresponding to the data sampling signal with the first logic level, correspond to a time delay of the multi-phase clock.

5. The method of claim 3, wherein selecting the sampling clock comprises selecting a clock C_{N+1}, when a clock sampling signal P_{N} and a data sampling signal Q_{N+1} have a first logic level, where the clock C_{N} is a clock corresponding to an N-th phase of the multi-phase clock, the clock sampling signal P_{N} indicates that the clock C_{N} is sampled at a rising edge of the reverse data signal, and the data sampling signal Q_{N+1} indicates that the reverse data signal is sampled at a rising edge of the clock C_{N+1}.

6. The method of claim 3, wherein selecting the sampling clock comprises selecting a clock C_{N+1}, when clock sampling signals P_{N} through P_{N+1} and data sampling signals Q_{N+1} through Q_{N+2} have a first logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the clocks C_{N+1} and C_{N+2}.

7. The method of claim 3, wherein selecting the sampling clock comprises selecting a clock C_{N+1}, when a clock sampling signal P_{N} and a data sampling signal Q_{N+2} have a first logic level, and a clock sampling signal P_{N+1} and a data sampling signal Q_{N+1} have a second logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the clocks C_{N+1} and C_{N+2}.

8. The method of claim 7, wherein the first logic level is logic ‘high’ and the second logic level is logic ‘low’.

9. The method of claim 3, wherein the host interface is included in a current mode bus interface system.

10. The method of claim 3, wherein the transition of the sampling clock corresponds to a falling edge of the sampling clock.

11. A reverse data sampling circuit of a host interface device, comprising:
a multi-phase clock generation unit configured to generate a multi-phase clock;
a selection signal generation unit configured to sample clocks corresponding to respective phases of the multi-phase clock to generate clock sampling signals at a transition of a reverse data signal, sample the reverse data signal at a transition of the clocks corresponding to the respective phases of the multi-phase clock to generate data sampling signals, and generate a selection signal by using the clock sampling signals and the data sampling signals;
a selection unit configured to select a sampling clock from the clocks corresponding to the respective phases of the multi-phase clock by using the selection signal; and
a sampling unit configured to sample reverse data at a transition of the sampling clock.

12. The reverse data sampling circuit of claim 11, wherein the selection signal generation unit selects, as the sampling clock, a clock that transitions in the same direction as the transition of the reverse data signal after the transition of the reverse data signal, from the clocks corresponding to the phases of the multi-phase clock.

13. The reverse data sampling circuit of claim 12, wherein the transition of the reverse data signal corresponds to a rising edge of the reverse data signal and the transition of the clocks corresponds to a rising edge of the clocks corresponding to the respective phases of the multi-phase clock.

14. The reverse data sampling circuit of claim 13, wherein the selection signal generation unit selects, as the sampling clock, a clock corresponding to the data sampling signal sampled with a first logic level, when the clock sampling signal with the first logic level corresponding to the multi-phase clock, and the data sampling signal with the first logic level corresponding to the multi-phase clock, correspond to a time delay of the multi-phase clock.

15. The reverse data sampling circuit of claim 13, wherein the selection signal generation unit selects the sampling clock by selecting a clock C_{N+1}, when a clock sampling signal P_{N} and a data sampling signal Q_{N+1} have a first logic level, where the clock C_{N} is a clock corresponding to an N-th phase of the multi-phase clock, the clock sampling signal P_{N} indicates that the clock C_{N} is sampled at a rising edge of the reverse data signal, and the data sampling signal Q_{N+1} indicates that the reverse data signal is sampled at a rising edge of the clock C_{N+1}.

16. The reverse data sampling circuit of claim 13, wherein the selection signal generation unit selects the sampling clock by selecting a clock C_{N+1}, when clock sampling signals P_{N} through P_{N+1} and data sampling signals Q_{N+1} through Q_{N+2} have a first logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the clocks C_{N+1} and C_{N+2}.

17. The reverse data sampling circuit of claim 13, wherein the selection signal generation unit selects the sampling clock by selecting a clock C_{N+1}, when a clock sampling signal P_{N} and a data sampling signal Q_{N+2} have a first logic level, and a clock sampling signal P_{N+1} and a data sampling signal Q_{N+1} have a second logic level, where the clock C_{N+1} is a clock corresponding to an (N+1)-th phase of the multi-phase clock, the clock sampling signals P_{N} and P_{N+1} indicate that the clocks C_{N} and C_{N+1} are sampled at a rising edge of the reverse data signal, and the data sampling signals Q_{N+1} and Q_{N+2} indicate that the reverse data signal is sampled at a rising edge of the clocks C_{N+1} and C_{N+2}.

18. The reverse data sampling circuit of claim 17, wherein the first logic level is logic ‘high’ and the second logic level is logic ‘low’.

19. The reverse data sampling circuit of claim 13, wherein the host interface device is included in a current mode bus interface system.

20. The reverse data sampling circuit of claim 13, wherein the transition of the sampling clock corresponds to a falling edge of the sampling clock.

21. The reverse data sampling circuit of claim 11, wherein the selection signal generation unit comprises:
a flip-flop unit including a plurality of flip-flops, the flip-flop unit samples the clocks corresponding to the respective phases of the multi-phase clock at the transition of the reverse data signal to generate the clock sampling signals, and samples the reverse data signal at the transition of the clocks corresponding to the phases of the multi-phase clock to generate the data sampling signals; and
a signal generation unit generates the selection signal by using the clock sampling signals and the data sampling signals.
